(19) United States
(12) Patent Application Publication
(10) Pub. No.: US 2016/0187893 A1
(43) Pub. Date: Jun. 30, 2016

(54) SYSTEM AND METHOD USING PARALLEL COMPRESSOR UNITS

(71) Applicant: Ingersoll-Rand Company, Davidson, NC (US)

(72) Inventor: Charles John Bergh, Berwyn, PA (US)

(21) Appl. No.: 14/957,965

(22) Filed: Dec. 3, 2015

Related U.S. Application Data
(60) Provisional application No. 62/098,942, filed on Dec. 31, 2014.

(51) Int. Cl. G05D 16/20; G05D 7/06

(52) U.S. Cl. CPC G05D 16/2073; G05D 7/0635

(57) ABSTRACT

A fluid compressor system and method are disclosed that includes multiple compressor modules arranged in parallel using a common intercooler and a common aftercooler to enable a more efficient scheme of matching the supply of compressed fluid generated by the system with variations in demand. The embodiments include systems, apparatuses, devices, and methods for generating a compressed fluid at a desired pressure and flow volume.

### CROSS REFERENCE TO RELATED APPLICATIONS

This application claims the benefit of U.S. Provisional Application No. 62/098,942, filed Dec. 31, 2014, which is incorporated herein by reference in its entirety.

### TECHNICAL FIELD

The present disclosure generally relates to compressor systems having multiple compressors.

### BACKGROUND

About 20% of a typical industrial plant's consumption of electricity has been estimated to be devoted to the production of compressed air for use within the plant. Compressed air is often used in a plant's pneumatic system to power equipment, tools, and other pneumatic devices and can often provide motive power in a cheaper, more flexible, and more reliable way than using a large number of electric motors or actuators. Many facilities have a need for other types of compressed gas, including compressed inert gases such as nitrogen. The demand for compressed gas may vary as the equipment connected to the pneumatic system is activated or deactivated. Accordingly, plant operators seek to match the supply of compressed gas provided via the plant's pneumatic system with the demand, both in terms of discharge pressure and flow volume (e.g., cubic feet per minute). To meet the peak demand, pneumatic systems will often include a compressor system having a nominal capacity. To meet lower demand conditions, such conventional pneumatic systems often reduce the pressure or flow volume of compressed gas from the nominal operating level by throttling the flow or via blowdown. The process of reducing the flow of compressed gas from a nominal condition is referred to as turndown. Blowdown refers to bleeding off a portion of the compressed gas from the pneumatic system to the ambient environment. Blowdown is inefficient because the energy to compress the gas has already been expended, yet the compressed fluid is not put to use. Likewise, throttling creates pressure losses and flow inefficiencies, which reduce the efficiency of the compressor system. Further, conventional compressors are limited in the degree of turndown while still maintaining sufficient operating pressure and flow. For example, centrifugal compressors can tolerate turndown of only about 30%, meaning their output can be reduced to about 70% of nominal and still preform adequately. Therefore, there remains a need for further contributions in this area of technology to enable a compressor system having a wider turndown range.

### SUMMARY

One embodiment of the present disclosure is a fluid compressor system that includes multiple compressor modules arranged in parallel using a common intercooler and a common aftercooler to enable a more efficient scheme of matching the supply of compressed fluid generated by the system with variations in demand. The embodiments include systems, apparatuses, devices, and methods for generating a compressed fluid at a desired pressure and flow volume.

### BRIEF DESCRIPTION OF THE FIGURES

Features of the disclosure will be better understood from the following detailed description when considered in reference to the accompanying drawings, in which:

FIG. 1 shows a schematic of an embodiment of a compressor system according to the present disclosure;

FIG. 2 shows a schematic of an embodiment of a compressor system according to the present disclosure;

FIG. 3 shows a perspective view of an embodiment of a compressor system according to the present disclosure; and

FIG. 4 illustrates a method of controlling the flow of a compressed fluid according to one embodiment of the present disclosure.

### DETAILED DESCRIPTION

The present application discloses various embodiments of a gas compressor and methods for using and constructing the same. In one aspect of the disclosure, a gas compressor may include a compressor system with multiple compressor modules arranged in parallel using a common intercooler and a common aftercooler. For the purposes of promoting an understanding of the principles of the disclosure, reference will now be made to the embodiments illustrated in the drawings, and specific language will be used to describe the same. It will nevertheless be understood that no limitation of the scope of the disclosure is thereby intended. Any alterations and further modifications in the described embodiments, and any further applications of the principles of the invention as described herein, are contemplated as would normally occur to one skilled in the art to which the disclosure relates having the benefit of the present disclosure.

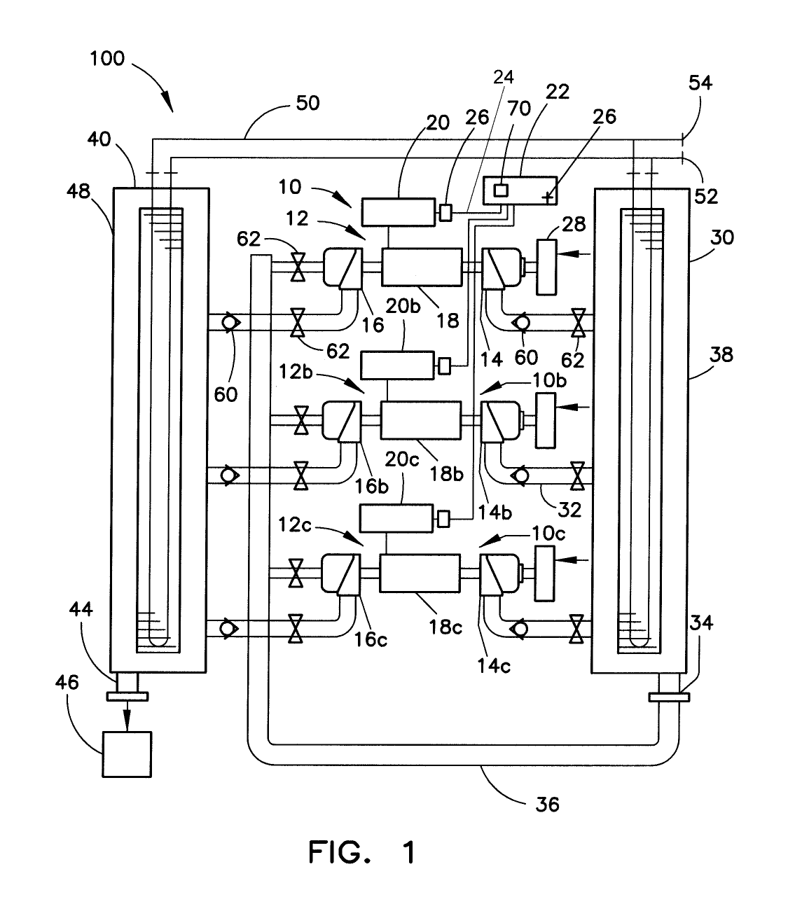

A compressor system according to at least one embodiment of the present disclosure is shown in FIG. 1. As shown in FIG. 1, a compressor system 100 may include a plurality of compressor modules 10 connected to each other in a parallel arrangement and structured to compress a fluid. The compressor system 100 is useful for compressing a gas, such as air, nitrogen or methane (i.e., natural gas), or a liquid, such as a refrigerant or water, more reliably and efficiently than conventional compressor systems. Each compressor module 10 may include a multistage compressor unit 12. Each compressor unit 12 may be a two-stage compressor including a low pressure stage 14 and a high pressure stage 16, where each stage 14, 16 is driven by the same motor 18. Further, as shown in FIG. 1, each compressor unit 12 may be a direct drive compressor, where a rotating shaft of the motor 18 is linked directly to the shafts of the low pressure stage 14 and high pressure stage 16. In such an embodiment, the speed of the compressor unit 12, including the low pressure stage 14 and high pressure stage 16, is substantially the same as the rotational speed of the motor 18. Though the compressor system 100 illustrated in FIG. 1 depicts compressor units 12 having two stages, the compressor units 12 may include a single stage or more than two stages. Though the compressor system 100 illustrated in FIG. 1 depicts three compressor modules 10 arranged in parallel, the compressor system 100 may include a greater or lesser number of compressor modules 10. The compressor units 12 of the compressor modules 10 may be any suitable type of compressor including but not limited to centrifugal compressors, twin screw compressors, single screw compressors, and the like. Each compressor module 10 may further include an intake filter 28 positioned upstream of an inlet to the low pressure stage 14 and structured to filter the fluid to be compressed before entering the low pressure stage 14. In certain embodiments, each compressor unit 12 may be share a single intake filter 28, whereby filtered gas is plumbed to each inlet of each low pressure stage 14.

As shown in FIG. 1, the individual compressor modules 10 may be fluidly connected in parallel to a common intercooler 30 and to a common aftercooler 40. The parallel arrangement of the individual compressor modules 10 enables the use of the common intercooler 30 and aftercooler 40 with additional benefits as described further herein. An outlet of each low pressure stage 14 may be fluidly connected to the intercooler 30 via a line 32, such that the intercooler 30 combines the compressed fluid generated by each low pressure stage 14. Disposed within the line 32 between the outlet of the low pressure stage 14 and the intercooler 30 may be a check valve 60 structured to prevent backflow into the outlet of the low pressure stage 14. Further disposed within the line 32 between the outlet of the low pressure stage 14 and the intercooler 30 may be an isolation valve 62 structured to selectively and reversibly interrupt fluid communication between the individual compressor modules 10 and the rest of the compressor system 100 as described further herein. In at least one embodiment, the isolation valve 62 may be disposed between the check valve 60 and the intercooler 30.

The intercooler 30 having an intercooler outlet 34 may be fluidly connected to an inlet of each high pressure stage 16 of each compressor unit 12. The intercooler 30 further may be fluidly connected to each inlet of each high pressure stage 16 via an intercooler line 36 extending from the intercooler outlet 34 to each inlet of the high pressure stages 16. In at least one embodiment, the compressor system 100 may include a separate intercooler line 36 for each compressor unit 12, such that the intercooler 30 includes at least as many intercooler outlets 34 as compressor units 12, and each separate intercooler line 36 extends from each intercooler outlet 34 to each high pressure stage 16. Further, in at least one embodiment, the intercooler line 36 may include another isolation valve 62 disposed between the intercooler outlet 34 and the inlet of each high pressure stage 16 to enable each high pressure stage 16 to be isolated from the intercooler 30 individually.

The aftercooler 40 may include a plurality of aftercooler inlets 42 by which an outlet of each high pressure stage 16 may be fluidly connected to the aftercooler 40, such that the aftercooler 40 combines the compressed fluid generated by each high pressure stage 16. Another isolation valve 62 may be positioned between the aftercooler 40 and the outlet of each high pressure stage 16 to enable each outlet to be isolated from the aftercooler 40. Further, a check valve 60 may be disposed between each outlet of the high pressure stage 16 and the aftercooler 40 to prevent backflow into the outlets of each high pressure stage 16. In at least one embodiment, the isolation valve 62 may be disposed between the check valve 60 and the outlet of each high pressure stage 16. The aftercooler 40 may further include at least one aftercooler outlet 44 through which the combined flows from the outlets of the high pressure stages 16, 16b, 16c may be discharged to a desired point of use 46. The desired point of use 46 may include but not be limited to a pneumatic distribution system to deliver the compressed fluid to specific equipment or tools or an accumulator to store the compressed fluid in reserve.

The intercooler 30 and aftercooler 40 may be any suitable type of heat exchanger, including but not limited to extended surface heat exchangers, such as shell and tube exchangers, plate and shell exchangers, and plate fin exchangers. In at least one embodiment as shown in FIG. 1, the intercooler 30 and aftercooler 40 may be shell and tube heat exchangers in which a coolant is flowed through a coolant line 50 housed within a shell, specifically an intercooler shell 38 of the intercooler 30 and an aftercooler shell 48 of the aftercooler 40. The intercooler 30 may be structured such that the compressed fluid from the low pressure stage 14 of the compressor unit 12 may flow across and around the coolant line 50 contained within the intercooler shell 38, thereby transferring heat from the compressed fluid to the coolant flowing through the coolant line 50. In at least one embodiment, the coolant line 50 within the intercooler 30 may include a plurality of tubes distributed through the intercooler volume defined by the intercooler shell 38. Similarly, the aftercooler 40 may be structured such that the compressed fluid from the high pressure stage 16 of the compressor unit 12 may flow across and around the coolant line 50 contained within the aftercooler shell 48, thereby transferring heat from the compressed fluid to the coolant flowing through the coolant line 50. In at least one embodiment, the coolant line 50 within the aftercooler 40 may include a plurality of tubes distributed through the aftercooler volume defined by the aftercooler shell 48.

The coolant line 50 extends from a coolant inlet 52, into and out of the intercooler 30 and aftercooler 40, and then out of a coolant outlet 54. In at least one embodiment, the intercooler 30 and aftercooler 40 may be plumbed in parallel such that coolant that has flowed through the intercooler 30 proceeds to the coolant outlet 54 and not to the aftercooler 40. The coolant inlet 52 and coolant outlet 54 may be fluidly connected to a recirculating supply of cooled coolant such that the temperature of the coolant at the coolant inlet 52 is generally constant. The coolant may be any suitable fluid including but not limited to water or refrigerant.

The intercooler 30 and aftercooler 40 may be sized to provide sufficient cooling capacity for the compressor modules 10 operating at a nominal capacity. Accordingly, as the number of compressor modules 10 included in the compressor system 100 increases so may the size, and thereby the cooling capacities, of the intercooler 30 and aftercooler 40. In at least one embodiment, the intercooler 30 and aftercooler 40 may be sized with excess cooling capacity for the number of compressor modules 10 included in the compressor system 100. In such an embodiment, the excess cooling capacity of the intercooler 30 and aftercooler 40 may enable additional compressor modules 10 to be added to the original compressor system 100 should future demand for compressed fluid exceed the available capacity of the compressor system 100. Consequently, the compressor system 100 may enable the efficient and relatively inexpensive creation of additional of cooling capacity by adding compressor modules 10, thereby avoiding the need to install an entire additional compressor system. The compressor system 100 may further include condensers and/or separators to remove unwanted moisture or other condensates from the flow of compressed fluid between compressor stages 14, 16 and/or before the point of use 46.

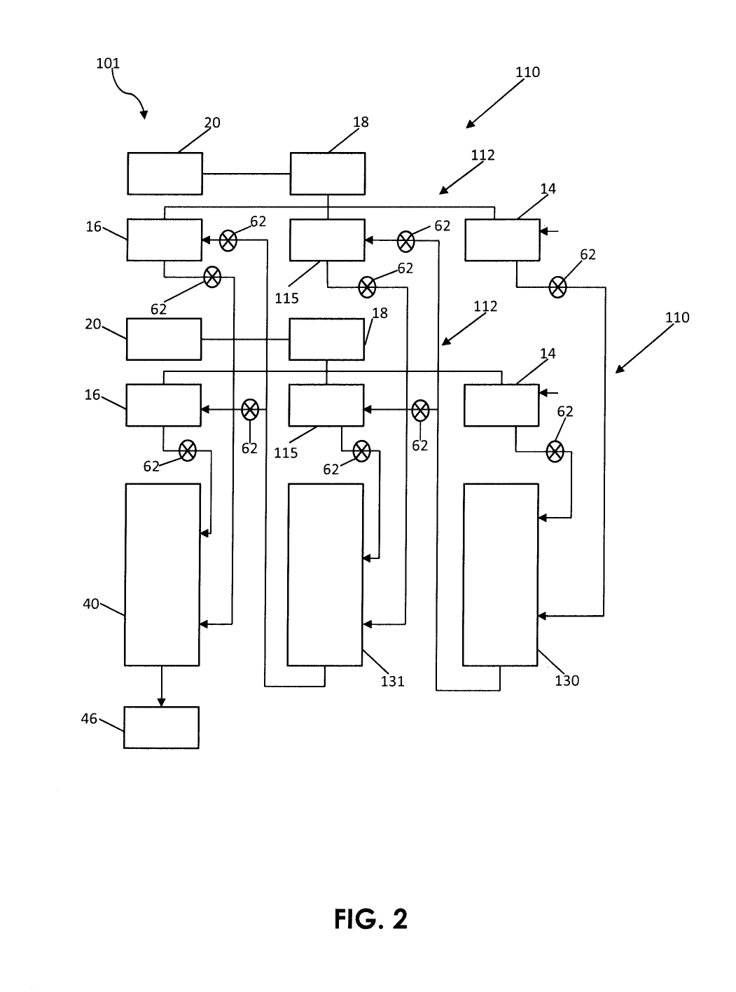

Shown in FIG. 2 is a portion of an alternative embodiment, the compressor system 101, including two compressor modules 110. Each compressor module 110 may include an electrical panel 20 and a compressor unit 112 having more than two stages 14, 16, namely additional stage 115, driven by a motor 18. In such an embodiment, each additional stage 115 may be in fluid communication with an upstream intercooler 130 and a downstream intercooler 131 and reversibly separated from the same by the isolation valves 62. Depending on which stages are adjacent the additional stage 115, the upstream intercooler 130 may be the upstream intercooler 30, and the downstream intercooler 131 may be the aftercooler 40. The upstream intercooler 130 and the downstream intercooler 131 may be structured similarly to the intercooler 30 and aftercooler 40. Likewise, the compressor module 110, including additional stages 115, may be structured and may operate the same as the compressor module 10 in other respects besides the additional stages 115. The compressor system 101 may further include the aftercooler 40 to cool the compressed fluid generated by the high pressure stages 16 of the compressor modules 110 and to provide the cooled compressed fluid to a point of use 46.

As illustrated in FIG. 1, each compressor module 10 may further include an electrical panel 20 electrically connected to the motor 18 and structured to provide electrical power to and control of the motor 18. The electrical panel 20 may include power management functions to monitor and control the output pressure and flow volume of compressed fluid from the compressor unit 12 driven by the motor 18. Each electrical panel 20 may further be electrically connected via a connector 24 to a main distribution panel 22, which is structured to provide electrical power to and control of the individual compressor modules 10, for example the compressor modules 10, 10b, 10c via their respective electrical panels 20a, 20b, 20c. The main panel 22 may include switches to enable each electrical panel 20 to be electrically isolated, disconnected, and reconnected from the compressor system 100. The main panel 22 may further include an input power connection 26 to enable a single external electrical power connection to the compressor system 100, from which power may be distributed to the individual electrical panels 20 and compressor modules 10. Accordingly, the main panel 22 enables a particular compressor module 10, for example the compressor module 10, to be disconnected from the compressor system 100 without affecting the operation of the remaining compressor modules 10b, 10c. Thus, maintenance of the individual compressor modules 10 and of the compressor system 100 is easier, more cost-effective, and less disruptive than conventional compressor systems as described further herein.

The compressor system 100 may further include a controller 70 in communication with the compressor modules 10. The controller 70 may be structured to control the compressor system 100. In certain embodiments, the controller 70 may be a portion of a processing subsystem including one or more computing devices having memory, processing, and communication hardware. The controller 70 may be a single device or a distributed device, and the functions of the controller 70 may be performed by hardware or software. The controller 70 may comprise digital circuitry, analog circuitry, or a hybrid combination of both of these types. The controller 70 may include one or more Arithmetic Logic Units (ALUs), Central Processing Units (CPUs), memories, limiters, conditioners, filters, format converters, or the like which are not shown to preserve clarity.

Further, the controller 70 may be programmable, an integrated state machine, or a hybrid combination thereof. In at least one embodiment, the controller 70 is programmable and executes algorithms and processes data in accordance with operating logic that is defined by programming instructions such as software or firmware. Alternatively or additionally, operating logic for the controller 70 may be at least partially defined by hardwired logic or other hardware. It should be appreciated that the controller 70 may be exclusively dedicated to regulating the pressure and flow volume of compressed fluid generated by each compressor module 10 or may further be used in the regulation, control, and/or activation of one or more other subsystems or aspects of the compressor system 100. Certain operations of the controller 70 described herein include operations to interpret one or more parameters. Interpreting, as utilized herein, includes receiving values by any method known in the art, including at least receiving values from a datalink or network communication, receiving an electronic signal (e.g., a voltage, frequency, current, or pulse-width modulation (PWM) signal) indicative of the value, receiving a software parameter indicative of the value, reading the value from a memory location on a non-transient computer readable storage medium, receiving the value as a run-time parameter by any means known in the art, and/or by receiving a value by which the interpreted parameter can be calculated, and/or by referencing a default value that is interpreted to be the parameter value.

By enabling a wide turndown range of the compressed fluid output, the compressor system 100 enables the continuous generation of compressed fluid while matching the demanded pressure and flow volume without wasteful blowdown flow or inefficient operation of the compressors, which are indicative of conventional systems. Conventional compressor systems typically reduce the pressure and/or flow volume of compressed fluid from a nominal operating level by throttling the or via blowdown. Blowdown is inefficient because the energy to compress the fluid has already been expended, yet a portion of the compressed fluid is not put to use. Likewise, throttling creates pressure losses and flow inefficiencies, thereby reducing the efficiency of the compressor system. The compressor system 100 overcomes these limitations and inefficiencies.

The modular parallel arrangement of the compressor modules 10, controlled by the controller 70 via the main panel 22, enable the compressor system 100 to adjust the pressure and flow volume of compressed fluid over a wider range of turndown and with greater efficiency than conventional compressor systems. For example, if the present demand for compressed fluid is about 65% of nominal (i.e., below the 70% turndown limit of conventional centrifugal compressors), the controller 70 may shut down one of the compressor modules 10, e.g., the compressor module 10c, to meet the current demand until demand increases, assuming a three-module system as shown in FIG. 1. With one module not producing compressed fluid, the remaining two active modules 10, 10b produce approximately two-thirds of the nominal capacity of the system 100. When the controller 70 shuts down the selected compressor module 10c, the controller 70 may also close the isolation valves 62 associated with the compressor module 10c, thereby isolating it from the system 100 and preventing pressure losses. In such an operating mode, electrical power consumption is reduced by a third. When demand returns to approximately a nominal level, the controller 70 may switch on the selected compressor module 10c and open the isolation valves 62 to enable the flow of compressed fluid generated by the compressor module 10c to contribute to the total output of compressed fluid produced by the compressor system 100. Embodiments of the compressor system 100 having more than three compressor modules 10 enable further turndown options. Specifically, a four-module system enables turndown in 25% increments, and a five-module system enables turndown in 20% increments and so on. Consequently, the compressor system 100 enables the adjustment of the output pressure and flow volume of compressed fluid without inefficient blowdown and/or throttling.

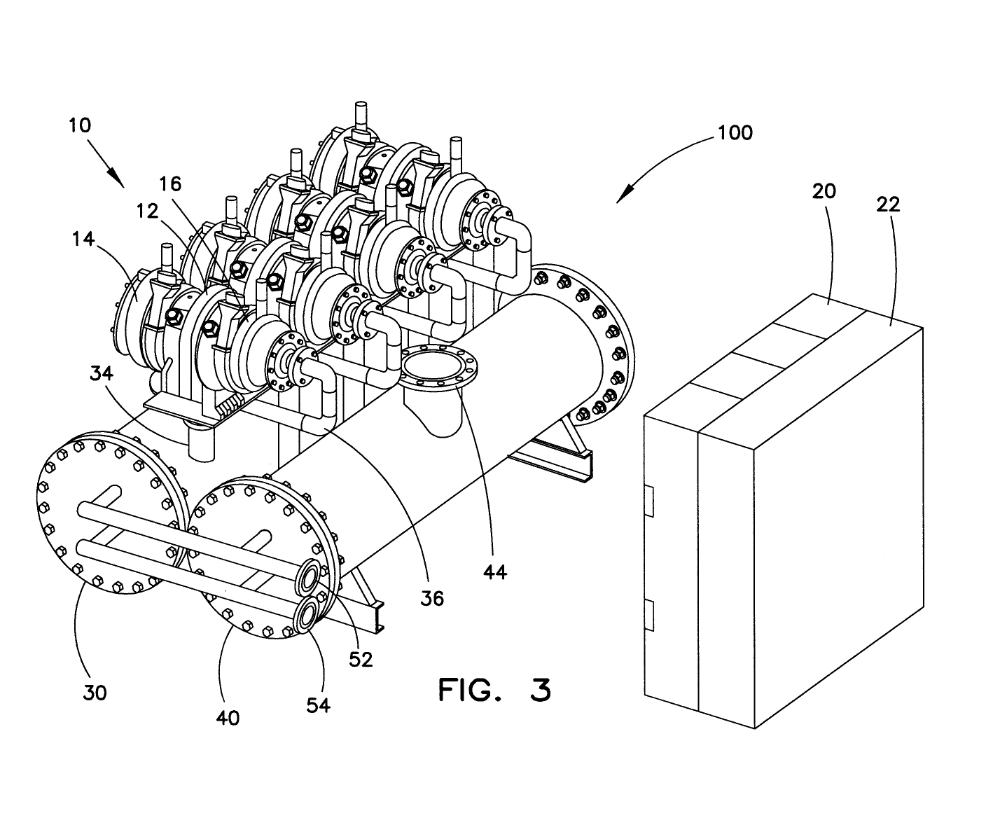

FIG. 3 shows an embodiment of the compressor system 100 having four compressor modules 10, including four compressor units 12, each having a low pressure stage 14 and a high pressure stage 16, and four electrical panels 20. Further shown in FIG. 3 are the intercooler 30, the aftercooler 40 having the aftercooler outlet 44, the coolant inlet 52, coolant outlet 54, and the main panel 22. As shown in FIG. 3, the compressor system 100 may include a separate intercooler line 36 for each compressor unit 12, such that the intercooler 30 includes at least as many intercooler outlets 34 as compressor units 12, and each separate intercooler line 36 extends from each intercooler outlet 34 to each high pressure stage 16.

The modular parallel arrangement of the compressor modules 10 of the compressor system 100 provides benefits besides a wider, more flexible turndown range. The thermodynamic efficiencies of the intercooler 30 and aftercooler 40 increase when a compressor module 10, such as the compressor module 10c in this example, is inactive. Because the intercooler 30 and aftercooler 40 are sized with sufficient capacity to cool the flow of compressed fluid at nominal levels, a reduced flow through the intercooler 30 and aftercooler 40 due to one or more inactive compressor modules 10 enables greater cooling of the reduced flow. Because cooler fluids are more easily compressed, less work (i.e., energy) is required to compress the fluid to the desired pressure and mass flow rate. Accordingly, the controller 70 may reduce the power provided to the active compressor modules 10, such as the modules 10, 10b, thus reducing the system's overall power consumption when less than nominal capacity is demanded.

In at least one embodiment according to the present disclosure, the compressor unit 12 may be a variable speed compressor, which enables the controller 70 to adjust the pressure and flow volume of compressed fluid by varying the speed of the motor 18, thereby varying the rotational speed of the compressor unit 12. In such an embodiment, the compressor system 100 may match the required demand for compressed fluid at a given flow volume and pressure by varying the speed of the motor 18. In certain embodiments, the variable speed compressor unit 10 may be driven by a variable-frequency drive, which converts the incoming alternating current electrical power to direct current and then back to quasi-sinusoidal alternating current power using an inverter switching circuit. Alternatively, the variable speed compressor unit 10 may be driven by a current-source inverter or other suitable means.

The compressor system 100 may further meet the current demand for compressed fluid at a given flow volume and pressure by both switching on or off one or more compressor modules 10 and varying the speed of the motors 18 associated with one or more compressor modules 10. For example, assuming a three-module system as shown in FIG. 1, if the present demand for compressed fluid is about 50% of nominal, the controller 70 may shut down one of the compressor modules 10, e.g., the compressor module 10c, and further reduce the speed of the remaining two active compressor modules 10, 10b such that each active compressor module 10, 10b generates approximately three fourths of its nominal individual capacity. Thus, the compressor system 100 under the forgoing conditions would generate approximately 50% of its nominal capacity. As described herein, when the controller 70 shuts down the selected compressor module 10c, the controller 70 may also close the isolation valves 62 associated with the compressor module 10c, thereby isolating it and preventing pressure loss to the now-inactive portion of the system 100. Consequently, the compressor system 100 enables the adjustment of the output pressure and flow volume of compressed fluid by various operations without inefficient blowdown and/or throttling. Moreover, the compressor system 100 enables a wide range of turndown conditions to fine tune the output of the system 100 to efficiently meet the current demand for compressed fluid compared to conventional compressor systems.

The compressor system 100 may further enable a reduction in system life-cycle cost relative to conventional compressor systems. The modular parallel arrangement of the compressor modules 10 enables compressor systems 100 having an expandable capacity by simply adding additional compressor modules 10 including identical compressor units 12. Accordingly, a single compressor unit 12 having a prescribed nominal capacity may be designed, developed and validated, and that compressor unit 12 may be incorporated into any number of identical compressor modules 10 to form a variety of the compressor systems 100 having a wide range of nominal capacities. In certain embodiments, the intercooler 30 and aftercooler 40 may be sized to provide greater cooling capacity than that required for the number of compressor modules 10 connected thereto. In such embodiments, additional compressor modules 10 may be incorporated into and connected in parallel to a preexisting compressor system 100 to increase the nominal capacity of the system 100 at a later date.

The cost of maintaining the compressor system 100 may be lower than conventional compressor systems. Because the modular parallel arrangement of the compressor modules 10 enables individual compressor modules 10 to be switched off and isolated from the active portions of the system 100, the compressor systems 100 enables maintenance of one or more compressor modules 10 without the need to turn off the entire compressor system 100. Any given compressor module 10 may be disconnected from the compressor system 100, repaired, or replaced without disrupting the operation of the compressor system 100. Further, the modularity of the electrical panels 20 enables any given electrical panel 20 to be disconnected from the main panel 22 via the connections 24 for service. Consequently, the cost of maintaining the compressor system 100 may be less than a conventional compressor system due to ease of servicing individual compressor modules 10, which represents portions of the total nominal capacity of the system 100, without taking the entire system 100 off line, which would disable 100% of its capacity.

In at least one embodiment according to the present disclosure, the compressor system 100 may include 300 kilowatt (kW) variable speed, direct drive compression units 12. In such an embodiment, the compression units 12 may be modified with incoming motor cooling air scroll centered to reduce width from about 31 inches (in.) to about 21 in. The cooling air scrolls may be orthogonal or angled. The intercooler 30 and aftercooler 40 may include an outer diameter of between about 20 in. and 28 in. In certain embodiments, the intercooler 30 and aftercooler 40 may have an outer diameter of 24 in. with two full length transverse flows and sized between about 150 and 200 kW per foot for good separation and reduced cost and weight. The piping between the compression units 12 and the intercooler 30 and aftercooler 40 may be sized at one size larger than the compressor unit nozzle diameter to reduce losses. Further, the electrical panels 20 may be 315 kW Eaton® LCX590A0-4A3N2 water-cooled drives rated at 315 kW at 590 amps (A). Water-cooled is appropriate and significantly reduces the size. The electrical panels 20 may be mounted in a four-bay cabinet as shown in FIG. 3. An attached cab with 4 bays on the back side holds individual disconnects. This solution will be required for medium voltage power required for large kilowatt machines.

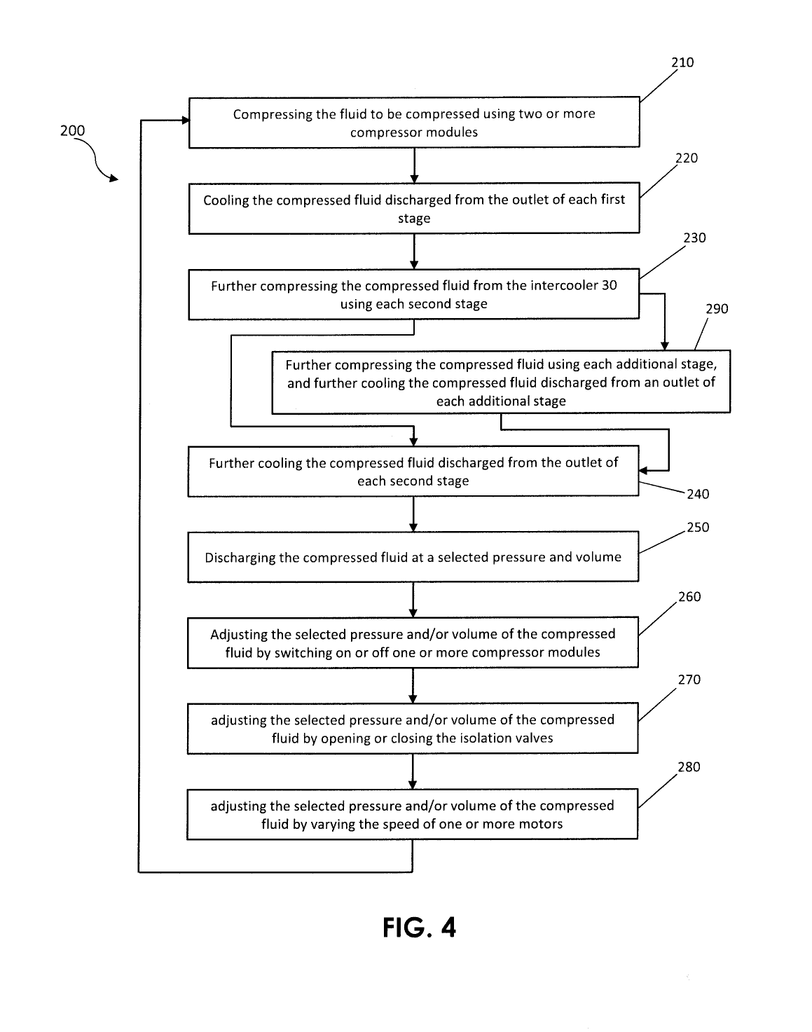

In at least one embodiment according to the present disclosure, the compressor system 100 may be used in a method 200 to control the pressure and flow volume of compressed fluid generated by the compressor system 100. As shown in FIG. 4, the method 200 may include an operation 210 of compressing the fluid to be compressed using two or more compressor modules 10. The method 200 may include an operation 220 of cooling the compressed fluid discharged from the outlet of low pressure first stage 14 of the two or more compressor modules 10 using the intercooler 30, which includes the at least one intercooler outlet 34 in further fluid communication with the inlet of each high pressure stage 16 of the two or more compressor modules 10. The method 200 may include an operation 230 of further compressing the compressed fluid from the intercooler 30 via the intercooler outlet 34 using each high pressure stage 16. The method 200 may include an operation 240 of further cooling the compressed fluid discharged from the outlet of each high pressure stage 16 using the aftercooler 40, and an operation 250 of discharging the compressed fluid at a selected pressure and flow volume from the at least one aftercooler outlet 44 to point of use 46. The method 200 may further include an operation 260 of adjusting the selected pressure and/or flow volume of the compressed fluid by switching on or off one or more compressor modules 10 using the controller 70.

In at least one embodiment, the method 200 may further include an operation 270 of adjusting the selected pressure and/or flow volume of compressed fluid by opening or closing the isolation valves 62 to selectively and reversibly separate one or more compressor modules 10 from the two or more compressor modules 10 using the controller 70. In certain embodiments, the method 200 may further include an operation 280 of adjusting the selected pressure and/or flow volume of compressed fluid by varying the speed of one or more motors 18 driving the two or more compressor modules 10, wherein each motor 18 is a variable speed motor controlled by the controller 70. In an embodiment in which the compressor units 12 include more than two stages, i.e., additional stages 115, the method 200 may include an operation 290 of further compressing the compressed fluid using each additional stage 115, and further cooling the compressed fluid discharged from an outlet of each additional stage 115 using a downstream intercooler 131 in fluid communication with the outlet of each additional stage 115. Accordingly, the compressor system 100 may be used with the method 200 to control the pressure and flow volume of compressed fluid generated by the compressor system 100. Specifically, the compressor system 100 may be used with the method 200 to efficiently match the output conditions of the compressed fluid with the current demand.

Embodiments of the present disclosure include a compressor system apparatus comprising: two or more compressors, each compressor structured to compress a fluid to generate a selected pressure and volume of compressed fluid and including at least two stages, a first stage and a second stage, driven by a motor mechanically connected to the first and second stages; an intercooler in fluid communication with an outlet of each first stage of the two or more compressors, the intercooler structured to combine and transfer heat from the compressed fluid generated by each first stage to a coolant flowing through the intercooler, the coolant separated from the compressed fluid, wherein the intercooler includes at least one intercooler outlet in further fluid communication with an inlet of each second stage of the two or more compressors, wherein the compressed fluid is further compressed by each second stage; an aftercooler in fluid communication with an outlet of each second stage of the two or more compressors, the aftercooler structured to combine and transfer heat from the compressed fluid generated by each second stage to the coolant flowing through the aftercooler, the coolant separated from the compressed fluid, wherein the aftercooler includes at least one aftercooler outlet in further fluid communication with a desired point of use; and a controller in communication with each of the two or more compressors, the controller structured to adjust the selected pressure and/or volume of compressed fluid by performing any one or more of operations switching on and off one or more compressors, switching open or closed two or more isolation valves, and varying the speed of two or more motors, first and second check valves positioned between the first stage and the intercooler and between the second stage and the aftercooler, respectively for each compressor, wherein the first check valve is structured to prevent a flow of compressed fluid from the intercooler into the first stage and the second check valve is structured to prevent a flow of compressed fluid from the aftercooler into the second stage.

In at least one embodiment, each compressor further comprises an electrical panel electrically connected to the motor, the electrical panel structured to supply power to and to control the motor, and the apparatus further comprises a main panel electrically connected to each electrical panel, the main panel including a connection to a remote power source and reversible connections to each electrical panel, such that the main panel distributes electrical power to each compressor via each electrical panel. In certain embodiments, the controller is disposed within the main panel. In further embodiments, the intercooler includes an intercooler flow path through which the coolant flows, the aftercooler includes an aftercooler flow path through which the coolant flows, and the intercooler flow path and the aftercooler flow path are connected to a coolant inlet and a coolant outlet, whereby the coolant may be circulated through the intercooler flow path and the aftercooler flow path.

In at least one embodiment, each compressor further comprises isolation valves disposed between the outlet of the first stage and the intercooler, between the intercooler and the second stage, and between the second stage and the aftercooler, wherein the isolation valves are structured to selectively and reversibly separate one or more desired compressors from the two or more compressors, the intercooler, and the aftercooler as commanded by the controller. In further embodiments, each motor of the two or more compressors is a direct drive motor controlled by the controller, whereby the first stage and the second stage are directly coupled to a drive shaft of the motor. In yet further embodiments, each motor of the two or more compressors is a variable speed motor controlled by the controller, the variable speed motor structured to adjust the pressure and volume of compressed fluid generated by its respective compressor by changing the rotational speed of the variable speed motor. In still further embodiments, each compressor includes one or more additional stages between the first stage and the second stage, each additional stage structured to further compress the fluid and in fluid communication with an upstream intercooler and a downstream intercooler.

Embodiments of the present disclosure include a method of generating a compressed fluid, the method comprising: compressing a fluid using two or more compressors, each compressor structured to compress the fluid to generate a selected pressure and volume of compressed fluid and including at least two stages, a first stage and a second stage, driven by a motor mechanically connected to the first and second stages; cooling the compressed fluid discharged from an outlet of each first stage of the two or more compressors using an intercooler in fluid communication with the outlet of each first stage, the intercooler structured to combine and transfer heat from the compressed fluid to a coolant flowing through the intercooler, wherein the intercooler includes at least one intercooler outlet in further fluid communication with an inlet of each second stage of the two or more compressors; compressing the compressed fluid further using each second stage; cooling the compressed fluid discharged from an outlet of each second stage of the two or more compressors further using an aftercooler in fluid communication with the outlet of each second stage, the aftercooler structured to combine and transfer heat from the compressed fluid to the coolant flowing through the aftercooler, wherein the aftercooler includes at least one aftercooler outlet in further fluid communication with a desired point of use; discharging the compressed fluid at a selected pressure and volume from the at least one aftercooler outlet to the point of use; and adjusting the pressure and/or volume of compressed fluid by switching on or off one or more compressors using a controller in communication with each compressor.

In at least one embodiment, the method further comprises adjusting the volume and/or pressure of compressed fluid by opening or closing isolation valves to separate one or more compressors from the two or more compressors, the isolation valves disposed between each first stage of the two or more compressors and the intercooler, between the intercooler and the second stage, and between the second stage and the aftercooler, and the isolation valves structured to selective and reversibly separate one or more desired compressors from the two or more compressors, the intercooler, and the aftercooler as commanded by the controller. In certain embodiments, the method further comprises adjusting the volume and/or pressure of compressed fluid by varying the speed of one or more motors driving the two or more compressors, wherein each motor is a variable speed motor controlled by the controller. In further embodiments, the method further comprises, prior to compressing the compressed fluid further using each second stage: compressing the compressed fluid further using each additional stage; cooling the compressed fluid discharged from an outlet of each additional stage further using a downstream intercooler in fluid communication with the outlet of each additional stage, the downstream intercooler structured to combine and transfer heat from the compressed fluid to the coolant flowing through the downstream intercooler.

While various embodiments of a compressor system and methods for constructing and using the same have been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible and are therefore contemplated by the inventor. Therefore, the particular order of the steps disclosed herein should not be construed as limitations of the present disclosure. Such sequences may be varied and still remain within the scope of the present disclosure.

1. A compressor apparatus, the apparatus comprising:
two or more compressors, each compressor structured to compress a fluid to generate a selected pressure and volume of compressed fluid and including at least two stages, a first stage and a second stage, driven by a motor mechanically connected to the first and second stages;
an intercooler in fluid communication with an outlet of each first stage of the two or more compressors, the intercooler structured to combine and transfer heat from the compressed fluid generated by each first stage to a coolant flowing through the intercooler, the coolant separated from the compressed fluid, wherein the intercooler includes at least one intercooler outlet in further fluid communication with an inlet of each second stage of the two or more compressors, wherein the compressed fluid is further compressed by each second stage;
an aftercooler in fluid communication with an outlet of each second stage of the two or more compressors, the aftercooler structured to combine and transfer heat from the compressed fluid generated by each second stage to the coolant flowing through the aftercooler, the coolant separated from the compressed fluid, wherein the aftercooler includes at least one aftercooler outlet in further fluid communication with a desired point of use;
a controller in communication with each of the two or more compressors, the controller structured to adjust the selected pressure and/or volume of compressed fluid by performing any one or more of operations switching on and off one or more compressors, switching open or closed two or more isolation valves, and varying the speed of two or more motors; and
first and second check valves positioned between the first stage and the intercooler and between the second stage and the aftercooler, respectively for each compressor, wherein the first check valve is structured to prevent a flow of compressed fluid from the intercooler into the first stage and the second check valve is structured to prevent a flow of compressed fluid from the aftercooler into the second stage.

2. The apparatus of claim 1, wherein each compressor further comprises an electrical panel electrically connected to the motor, the electrical panel structured to supply power to control the motor, and
wherein the apparatus further comprises a main panel electrically connected to each electrical panel, the main panel including a connection to a remote power source and reversible connections to each electrical panel, such that the main panel distributes electrical power to each compressor via each electrical panel.

3. The apparatus of claim 2, wherein the controller is disposed within the main panel.

4. The apparatus of claim 1, wherein the intercooler includes an intercooler flow path through which the coolant flows, and the aftercooler includes an aftercooler flow path through which the coolant flows, and wherein the intercooler flow path and the aftercooler flow path are connected to a coolant inlet and a coolant outlet, whereby the coolant may be circulated through the intercooler flow path and the aftercooler flow path.

5. The apparatus of claim 1, wherein each compressor includes isolation valves disposed between the outlet of the first stage and the intercooler, between the intercooler and the second stage, and between the second stage and the aftercooler.

6. The apparatus of claim 5, wherein the isolation valves are structured to selectively and reversibly separate one or more desired compressors from the two or more compressors, the intercooler, and the aftercooler as commanded by the controller.

7. The apparatus of claim 1, wherein each motor of the two or more compressors is a direct drive motor controlled by the controller, whereby the first stage and the second stage are directly coupled to a drive shaft of the motor.

8. The apparatus of claim 7, wherein each motor of the two or more compressors is a variable speed motor controlled by the controller, the variable speed motor structured to adjust the pressure and volume of compressed fluid generated by its respective compressor by changing the rotational speed of the variable speed motor.

9. The apparatus of claim 1, wherein each compressor includes one or more additional stages between the first stage and the second stage, each additional stage structured to further compress the fluid and in fluid communication with an upstream intercooler and a downstream intercooler.

10. A method of generating a compressed fluid, the method comprising:
compressing a fluid using two or more compressors, each compressor structured to compress the fluid to generate a selected pressure and volume of compressed fluid and including at least two stages, a first stage and a second stage, driven by a motor mechanically connected to the first and second stages;
cooling the compressed fluid discharged from an outlet of each first stage of the two or more compressors using an intercooler in fluid communication with the outlet of each first stage, the intercooler structured to combine and transfer heat from the compressed fluid to a coolant flowing through the intercooler, wherein the intercooler includes at least one intercooler outlet in further fluid communication with an inlet of each second stage of the two or more compressors;
compressing the compressed fluid further using each second stage;
cooling the compressed fluid discharged from an outlet of each second stage of the two or more compressors further using an aftercooler in fluid communication with the outlet of each second stage, the aftercooler structured to combine and transfer heat from the compressed fluid to the coolant flowing through the aftercooler, wherein the aftercooler includes at least one aftercooler outlet in further fluid communication with a desired point of use;
discharging the compressed fluid at a selected pressure and volume from the at east one aftercooler outlet to the point of use; and
adjusting the pressure and/or volume of compressed fluid by switching on or off one or more compressors using a controller in communication with each compressor.

11. The method of claim 10, the method further comprising:
adjusting the volume and/or pressure of compressed fluid by opening or closing isolation valves to separate one or more compressors from the two or more compressors, the isolation valves disposed between each first stage of the two or more compressors and the intercooler, between the intercooler and the second stage, and between the second stage and the aftercooler, and the isolation valves structured to selectively and reversibly separate one or more desired compressors from the two or more compressors, the intercooler, and the aftercooler as commanded by the controller.

12. The method of claim 10, the method further comprising:
adjusting the volume and/or pressure of compressed fluid by varying the speed of one or more motors driving the two or more compressors, wherein each motor is a variable speed motor controlled by the controller.

13. The method of claim 10, wherein each compressor further comprises an electrical panel electrically connected to the motor, the electrical panel structured to supply power to and to control the motor.

14. The method of claim 13, wherein the controller is disposed within a main panel, the main panel electrically connected to each electrical panel, the main panel including a connection to a remote power source and reversible connections to each electrical panel, such that the main panel distributes electrical power to and controls each compressor via each electrical panel.

15. The method of claim 10, wherein the intercooler includes an intercooler flow path through which the coolant flows, and the aftercooler includes an aftercooler flow path through which the coolant flows, and wherein the intercooler flow path and the aftercooler flow path are connected to a coolant inlet and a coolant outlet, whereby the coolant may be circulated through the intercooler flow path and the aftercooler flow path.

16. The method of claim 10, wherein each compressor further comprises a first check valve disposed between the outlet of the first stage and the intercooler, the first check valve structured to prevent a flow of compressed fluid from the intercooler into the first stage.

17. The method of claim 10, wherein each compressor further comprises a second check valve disposed between the outlet of the second stage and the aftercooler, the second check valve structured to prevent a flow of compressed fluid from the aftercooler into the second stage.

18. The method of claim 10, wherein each motor of the two or more compressors is a direct drive motor controlled by the controller, whereby the first stage and the second stage are directly coupled to a drive shaft of the motor.

19. The method of claim 10, wherein each compressor includes one or more additional stages between the first stage and the second stage, each additional stage structured to further compress the fluid and in fluid communication with an upstream intercooler and a downstream intercooler, and wherein the method further comprises, prior to compressing the compressed fluid further using each second stage:
compressing the compressed fluid further using each additional stage;
cooling the compressed fluid discharged from an outlet of each additional stage further using a downstream intercooler in fluid communication with the outlet of each additional stage, the downstream intercooler structured to combine and transfer heat from the compressed fluid to the coolant flowing through the downstream intercooler.

20. A modular compressor system comprising:
a plurality of compressors having at least two compression stages;
a first manifold operable to receive compressed fluid flow from a first stage of each compressor in parallel;
a second stage of each compressor operable to receive compressed fluid from the first manifold in parallel;
a second manifold operable to receive compressed fluid from the second stage of each of the compressors;
a first valve positioned in a flowpath between each of the first stages and the first manifold;
a second valve positioned in a flowpath between each of the second stages and the second manifold;
an independent motive source operably coupled to each compressor; and
an independent electrical source operably coupled to each of the independent motive sources.

21. The modular compressor system of claim 20, wherein a compressor can be removed and or added while the system remains operational.

22. The modular system of claim 20 wherein the first and second manifolds are heat exchangers.
